(19) United States
(12) Patent Application Publication
(10) Pub. No.: US 2015/0091754 A1
(43) Pub. Date: Apr. 2, 2015

(54) UNAMBIGUOUS CODE TRACKING SYSTEM FOR GLOBAL NAVIGATION SATELLITE SYSTEMS

(71) Applicant: Broadcom Corporation, Irvine, CA (US)

(72) Inventors: Jaleh KOMAILI, Irvine, CA (US); Charles NORMAN, Huntington Beach, CA (US); Andreas WARLOE, Fountain Valley, CA (US)

(73) Assignee: Broadcom Corporation, Irvine, CA (US)

(21) Appl. No.: 14/058,165

(22) Filed: Oct. 18, 2013

Related U.S. Application Data
(60) Provisional application No. 61/884,875, filed on Sep. 30, 2013.

(51) Int. Cl. H04B 1/7085; G01S 19/30; H04B 1/7093

(52) U.S. Cl. CPC H04B 1/7085; H04B 1/7093; G01S 19/30; H04B 2001/70706
USPC 342/357.69; 375/149

(57) ABSTRACT

A method of tracking a code phase includes configuring local correlators with a first de-spreading local function; de-spreading an incoming signal with the first de-spreading local function to generate a first correlation output; determining a range estimate based on the first de-spreading local function; reconfiguring the local correlators with a second de-spreading local function when a delay-locked loop has locked to a correct correlation peak of the first correlation output; de-spreading the incoming signal with the second de-spreading local function to generate a second correlation output; determining a range estimate based on the second de-spreading local function that has a higher resolution than the range estimate based on the first de-spreading local function; and determining if the delay-locked loop has lost a lock to the correct correlation peak of the second correlation output to determine that the local correlators need to be reconfigured with the first de-spreading local function.

### CROSS-REFERENCE TO RELATED APPLICATIONS

The present application claims the benefit of U.S. Provisional Patent Application Ser. No. 61/884,875, titled “UNAMBIGUOUS CODE TRACKING SYSTEM FOR GLOBAL NAVIGATION SATELLITE SYSTEMS,” filed on Sep. 30, 2013, which is hereby incorporated by reference in its entirety for all purposes.

### TECHNICAL FIELD

The present description relates to satellite communication systems, and more particularly, but not exclusively, to satellite signal acquisition and tracking

### BACKGROUND

The United States' Global Positioning System (GPS), the Russian Global Navigation Satellite System (GLONASS), the Chinese satellite navigation system Beidou, and the European satellite navigation system Galileo are several examples of Global Navigation Satellite Systems (GNSS). Various GNSS measurements such as pseudo-range, carrier phase, and/or Doppler may be used by GNSS receivers to calculate navigation information such as GNSS receiver positions, velocity, and time. Most GNSS systems, including Galileo, use Code Division Multiple Access (CDMA) techniques to multiplex several satellite signals onto the same carrier frequency. The basic concept behind the CDMA schemes is that each satellite is assigned a Pseudo-Random Noise (PRN) code that modulates the transmitted signal. The PRN codes have properties such that their autocorrelation function (ACF) is at a maximum when they are completely aligned. GNSS receivers have prior knowledge of each satellite's PRN code, and correlate the incoming satellite signals with local code replicas, to determine if a given satellite is visible or not.

In Galileo, each component of the transmitted signal, in addition to the PRN code, is modulated with a binary offset carrier (BOC) modulation scheme. The BOC modulation scheme presents multiple correlation peaks in a corresponding ACF depending on the order of the BOC modulation (e.g., BOC(m,n), where m=fsc/fo and n=fc/fo; fo is the reference frequency, fc is the carrier frequency and fsc is the sub-carrier rate). Moreover, the main correlation peak has a very steep slope. Although the narrower peak makes the range measurement more accurate, the multiple minor peaks make the DLL operation ambiguous when the DLL locks on to one of the secondary correlation peaks resulting in an incorrect range estimate or an unstable delay-locked loop.

### BRIEF DESCRIPTION OF THE DRAWINGS

The accompanying drawings, which are included to provide further understanding of the subject technology and are incorporated in and constitute a part of this specification, illustrate aspects of the subject technology and together with the description serve to explain the principles of the subject technology.

FIG. 1 is a diagram illustrating an exemplary communication system that is operable to support satellite communications over mobile devices that are integrated with global navigation satellite system (GNSS) modules, in accordance with various aspects of the subject technology.

FIG. 2 is a block diagram illustrating an example of a GNSS enabled receiver in accordance with various aspects of the subject technology.

FIG. 3 is a flowchart illustrating an example of a method of tracking a code phase, in accordance with various aspects of the subject technology.

FIG. 4 is a diagram illustrating an example of a correlation function based on multiple delay taps, in accordance with various aspects of the subject technology.

FIG. 5 conceptually illustrates an electronic system with which aspects of the subject technology may be implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, the subject technology is not limited to the specific details set forth herein and may be practiced using one or more implementations. In one or more instances, structures and components are shown in block diagram form in order to avoid obscuring the concepts of the subject technology.

The subject disclosure provides a method of unambiguously tracking a code phase in GNSS receivers (e.g., Galileo E1 band receiver). The subject technology provides a de-spreading system implemented with a delay-locked loop (DLL) that assigns early and late taps of a local reference waveform (e.g., predetermined correlation function) with a first local code replica consisting of a PRN sequence to be correlated with an incoming BOC×PRN signal to take advantage of the larger dynamic range, and assigns a prompt tap (or prompt tap group) with a second local code replica consisting of a BOC×PRN sequence to calculate the prompt power. The prompt power may be provided for normalizing the DLL and remaining code and frequency tracking functions. The local reference waveform may be configured to include at least three tap delays for proper operation but may be programmed with more tap delays to produce additional information about the system. The hardware allows configuring the taps in terms of their relative chip spacing and local de-spreading function, e.g., PRN sequence or BOC×PRN sequence. In this regard, the early and late taps are calculated as a (BOC×PRN)×PRN correlation output, while the prompt tap is calculated as a (BOC×PRN)×(BOC×PRN) correlation output in an initial tracking configuration of the de-spreading system. A DLL loop discriminator can be implemented as early minus late, dot product or high resolution correlation (HRC) with the flexible number of taps, tap spacing and the method of de-spreading. Once the range is tracked with stability, the de-spreading system can be reconfigured into an enhanced tracking configuration where the (BOC×PRN)×(BOC×PRN) de-spreading is used for the early and late taps to take advantage of the narrower ACF peak to obtain better range resolution while monitoring for a loss of DLL lock, in which case the de-spreading system is reconfigured back to the initial tracking configuration.

In certain aspects, a method of tracking a code phase includes configuring local correlators with a first de-spreading local function; de-spreading an incoming satellite signal with the first de-spreading local function to generate a first correlation output; determining a range estimate based on the first de-spreading local function; reconfiguring the local correlators with a second de-spreading local function when a delay-locked loop has locked to a correct correlation peak of the first correlation output; de-spreading the incoming satellite signal with the second de-spreading local function to generate a second correlation output; determining a range estimate based on the second de-spreading local function that has a higher resolution than the range estimate based on the first de-spreading local function; and determining if the delay-locked loop has lost a lock to the correct correlation peak of the second correlation output to determine that the local correlators need to be reconfigured with the first de-spreading local function. The method may include receiving an input representing the incoming satellite signal from one or more global navigation satellite system (GNSS) satellites; selecting between a first de-spreading code and a second de-spreading code based on a tap delay of a local reference waveform; and de-spreading the input with the selected de-spreading code.

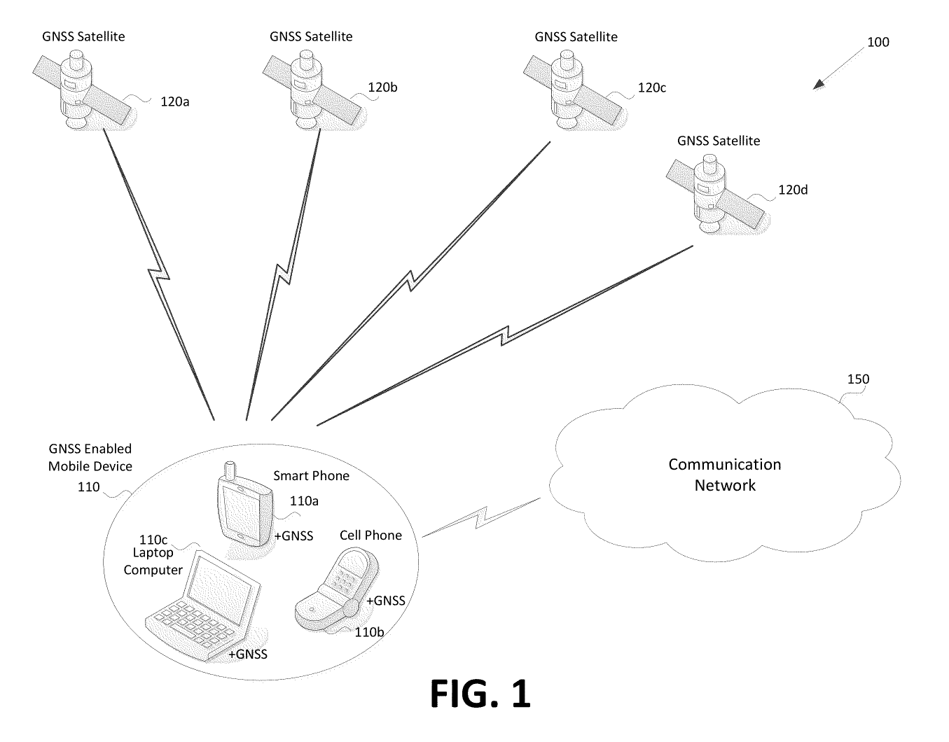

FIG. 1 is a diagram illustrating an exemplary communication system 100 that is operable to support satellite communications over mobile devices that are integrated with global navigation satellite system (GNSS) modules, in accordance with one or more implementations of the subject technology. Not all of the depicted components may be required, however, and one or more implementations may include additional components not shown in the figure. Variations in the arrangement and type of the components may be made without departing from the spirit or scope of the claims as set forth herein. Additional components, different components, or fewer components may be provided.

The communication system 100 includes multiple GNSS-enabled mobile devices 110, of which GNSS-enabled mobile devices 110a-110c are illustrated, a GNSS infrastructure 120, and a communication network 130. The GNSS infrastructure 120 includes multiple GNSS satellites, of which GNSS satellites 120a-120d are presented. The Global Positioning System (GPS), the Global Orbiting Navigation Satellite System (GLONASS), the navigation satellite system Beidou (or Compass), and the navigation satellite system Galileo are four examples of Global Navigation Satellite Systems (GNSSs). Various GNSS measurements such as pseudo-range, carrier phase, and/or Doppler may be used by GNSS receivers (e.g., GNSS enabled mobile devices 110a-110c) to calculate navigation information such as GNSS receiver positions, velocity, and time.

A GNSS-enabled mobile device, such as GNSS-enabled mobile device 110a, may be operable to concurrently communicate radio frequency signals using multiple radio communication technologies. The radio communication technologies may be integrated within a GNSS integrated circuit chip integrated inside the GNSS-enabled mobile device 110a. Using the GNSS integrated circuit chip, the GNSS-enabled mobile device 110a may be operable to concurrently communicate radio frequency signals across, for example, the communication network 130. The GNSS-enabled mobile device 110a may be operable to take full GNSS measurements from GNSS radio frequency signals received from visible GNSS satellites such as the GNSS satellites 120a-120d. The full GNSS measurement may include pseudo-range, carrier phase, and/or Doppler, which may be calculated using the received GNSS signals from visible GNSS satellites of a full GNSS satellite constellation (e.g., GPS, Galileo, GLONASS, and Beidou). The full GNSS measurements may be calculated inside the GNSS integrated circuit chip.

The GNSS enabled mobile device 110a may include correlators within the GNSS integrated circuit chip to search and/or detect GNSS radio frequency signals from the visible GNSS satellites such as the GNSS satellites 120a-120d. Specific time and/or location related information embedded in radio frequency signals received from, for example, the communication network 130 may be extracted. The extracted specific time and/or location related information may be used as GNSS reference information or GNSS assistance data. The GNSS-enabled mobile device 110a may be operable to provide or input the extracted GNSS reference information into the integrated GNSS integrated circuit chip to assist the full GNSS measurement.

The full GNSS measurement may be processed via a navigation process to calculate a full navigation solution. The full navigation solution may include GNSS time tagged navigation information such as, for example, a position, orientation, attitude, velocity, and/or clock information of the GNSS-enabled mobile device 110a. The navigation process may be performed internal to and/or external to the integrated GNSS integrated circuit chip depending on where a corresponding navigation engine would be. The full GNSS navigation solution may be applied to various navigation services such as, for example, traffic alerts on the GNSS-enabled mobile device 110a. The GNSS-enabled mobile device 110a may be operable to concurrently transmit and receive frequency modulation (FM) radio frequency signals over an integrated FM radio to support multiple location-based services such as, for example, traffic alerts and turn-by-turn navigation, at the same time.

A GNSS satellite such as the GNSS satellite 120a may be operable to provide satellite navigational information to various GNSS receivers on earth. The GNSS receivers, which include GPS, Galileo, Beidou and/or GLONASS receivers, may be integrated internally to or externally coupled to GNSS-enabled mobile devices such as the GNSS-enabled mobile devices 110a-110c. The GNSS satellite 120a may be operable to broadcast its own ephemeris periodically, for example, once every specified period of time (e.g., 30 seconds). The broadcast ephemeris may be utilized by the GNSS integrated circuit chip to calculate navigation information such as, for example, a position, velocity, and/or clock information of the GNSS receivers. In this regard, the GNSS integrated circuit chip is utilized to calculate the navigation information without intervention from a host processor in corresponding GNSS-enabled mobile devices.

The communication network 130 may include multiple base stations. The communication network 130 may be operable to provide data services to various mobile devices such as the GNSS-enabled mobile devices 110a-110c by using cellular communication technologies and/or Worldwide Interoperability for Microwave Access (WiMAX) technology. The cellular communication technologies may include, but not limited to, Global System for Mobile communications (GSM), General Packet Radio Services (GPRS), Universal Mobile Telecommunications System (UMTS), Enhanced Data rates for GSM Evolution (EDGE), Enhanced GPRS (EGPRS), and/or 3GPP Long Term Evolution (LTE).

The communication network 130 may be operable to communicate radio frequency signals including specific physical location information such as an International Mobile Subscriber Identity (IMSI), a Mobile Network Code (MNC), a Mobile Country Code (MCC), a Location Area Code (LAC), Cell ID, a Radio Network Controller (PNC) ID, and/or a base station ID. The specific physical location information embedded in the received radio frequency signals may provide information, for example, service providers and/or service serving areas. The embedded specific physical location information may be utilized by, for example, the GNSS-enabled mobile device 110a as GNSS reference information or GNSS assistance data to assist full GNSS measurement within a corresponding GNSS integrated circuit chip. The communication network 130 also may represent a Bluetooth® network, a wireless local area network (WLAN), a wireless wide area network (WAN), a near-field communication network, a broadcast network, or a multicast network.

In operation, each of the GNSS satellites 120a-120d broadcast a radio signal (GNSS signal) upon which is modulated certain information. The GNSS receiver (e.g., mobile devices 110a-110c) captures the broadcast satellite signal, extracts the information modulated upon the signal, and computes an estimate of the position of the GNSS receiver using the information. In Galileo, the broadcast satellite signal (e.g., Galileo E1 Band Open Access Service Signal) is designed to share the same carrier frequency and the same concept of direct sequence CDMA system as the GPS L1 signal. More specifically, the receiver position is determined by computing, for each satellite in view of the GNSS receiver, a time delay between the time of the transmission from the satellite such as GNSS satellite 120a and a time of reception of the satellite signal at the GNSS receiver such as mobile device 110a. The time delay multiplied by the speed of light provides a distance (e.g., a pseudo-range) from the GNSS receiver to the GNSS satellite 120a, for example. Using pseudo-ranges to a number of satellites, the receiver computes the position.

To enable the GNSS receiver to extract information from the GNSS signals, the carrier frequency and the code delay (which is indicative of the pseudo-range) must be determined and tracked. The GNSS signal is modulated with a pseudorandom (PN) code (or sometimes referred to as pseudorandom noise sequence) that is correlated with a local PN code replica in the GNSS receiver. The correlation process produces an estimate of frequency and code delay. The code delay may quantify the misalignment between the local PN code replica and the incoming satellite signal.

These estimates vary over time due to motion of the GNSS receiver relative to the GNSS satellites 120a-120d, satellite motion through space, or clock inaccuracies. As such, time and frequency tracking loops are used to continuously track the incoming satellite signal. These loops utilize discriminators that derive a time and/or frequency error and apply the error to the frequency or timing loop to compensate for the error. In this regard, each estimate of the code delay and carrier phase (or frequency) is used to regenerate the local PN code replica, which is then correlated again with the incoming satellite signal. Such loops (e.g., delay, phase or frequency lock loops) are well known and are widely used in GNSS receivers.

Galileo employs Binary Offset Carrier (1,1) (or BOC(1,1)) modulation, which is aimed to provide the advantages of multipath effect reduction and narrow band interference rejection. However, signal processing by the GNSS receivers such as mobile devices 110a-110c may experience signal loss because of poor tracking loop (e.g., delay-locked loop) stability due to the wide frequency spectrum of the Galileo E1 band signal and the ambiguous secondary peaks on the Galileo E1 band signal ACF.

An approach in dealing with a false DLL lock is an algorithm called “bump and jump” that tracks the size of a correlation peak, and if a larger peak is detected, the DLL lock moves to the larger peak. This approach can result in tracking and reporting the wrong range estimate and/or a longer processing time for the GNSS receiver to produce correct range estimates. Another approach to the “bump and jump” algorithm is computing a cross-correlation function (CCF) between the incoming satellite signal (e.g., transmitted signal modulated with PRN and BOC sequences) and a local PRN sequence. The CCF approach increases the dynamic range of the DLL discriminator by providing a more relaxed slope but at the cost of a lower discriminator gain.

The subject technology allows the Galileo code tracking loop to take advantage of the existing GNSS system infrastructure, hence avoiding additional cost and power consumption. The subject technology is distinguishable from the known “bump & jump” algorithm by generating a receiver position faster due to not needing a trial period of examining the locked peak, and also being immune to occasional loss of DLL lock due to heuristic threshold settings. The subject technology is also distinguishable from the aforementioned approaches by preserving the accuracy of the detected larger gain peak by using (BOC×PRN)×(BOC×PRN) de-spreading on the prompt tap, and extending the dynamic range of the DLL discriminator by using (BOC×PRN)×(PRN) de-spreading on the early and late tap delays.

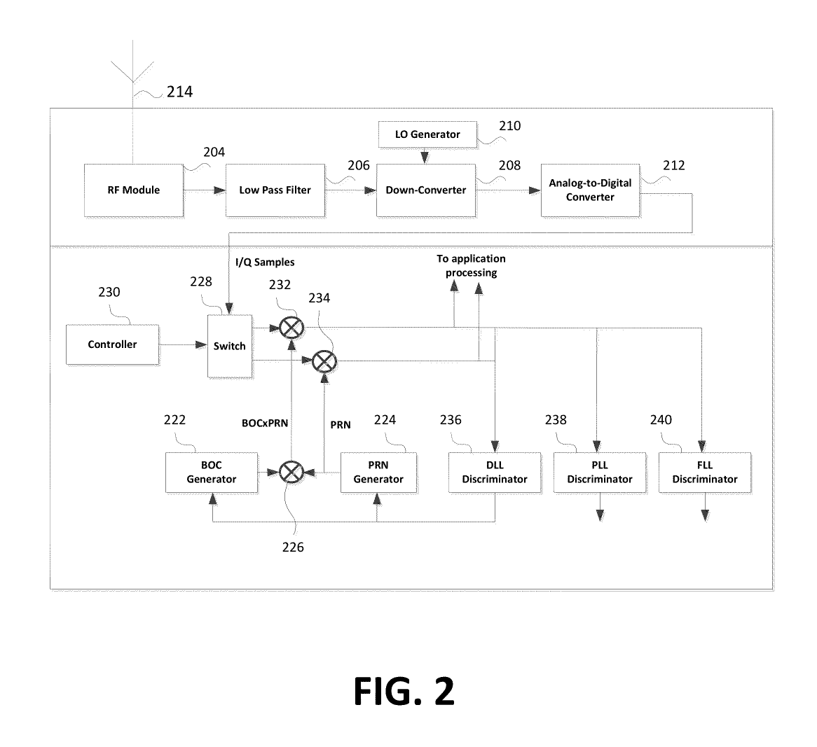

FIG. 2 is a block diagram illustrating an example of a GNSS enabled receiver 200 in accordance with various aspects of the subject technology. Not all of the depicted components may be required, however, and one or more implementations may include additional components not shown in the figure. Variations in the arrangement and type of the components may be made without departing from the spirit or scope of the claims as set forth herein. Additional components, different components, or fewer components may be provided.

The GNSS enabled receiver 200 includes a receiver front-end 202, a baseband processor 220, and an antenna 214. The GNSS enabled receiver 200 may include a memory (not shown) for data storage and a user interface (not shown).

The receiver front-end 202 includes an RF module 204, a low-pass filter 206, a down-converter 208, a local oscillator (LO) generator 210, and an analog-to-digital converter 212. In some aspects, the receiver front-end 202 includes an amplifier (not shown) coupled to the RF module 204. In this regard, the receiver front-end 202 can down-convert, filter, amplify and digitize the incoming satellite signals (e.g., Galileo E1 band signals) into a baseband representation of the desired GNSS spectrum, yielding the samples as real and complex components, namely I (In-Phase) and Q (Quadrature) components, in baseband. The antenna 214 may be configured to capture the incoming satellite signals.

The baseband processor 220 includes a BOC generator 222, a PRN generator 224, a multiplier 226, a switch 228, a controller 230, correlators 232 and 234, a DLL discriminator 236, a phase-locked loop (PLL) discriminator 238 and a frequency-locked loop (FLL) discriminator 240. The baseband processor 220 is configured to process the down-converted and digitized GNSS signal to provide code pseudo-ranges, carrier phase measurements, navigation data, Doppler frequency measurements, carrier-to-noise ratio information and lock indications.

The baseband processor 220 may be replicated over multiple channels of the GNSS enabled receiver 200. In this regard, each channel may process a given GNSS signal (e.g., the baseband representation) from a given GNSS satellite such as GNSS satellite 120a to provide GNSS measurements and navigation data.

The GNSS enabled receiver 200 may enter an acquisition mode, where the GNSS enabled receiver 200 determines which of the GNSS satellites 120a-120d are in view and can be tracked for extracting GNSS measurements. The acquisition mode may be based on multiple correlations between the incoming satellite signal and multiple replicas of the possible “expected” GNSS signal, generated for different code delays and Doppler frequencies, for example. When the local code replica and the incoming satellite signal are aligned, their correlation generates a peak, and the code delay and/or Doppler frequency corresponding to this peak may be a possible estimate to initiate a tracking mode by the GNSS enabled receiver 200. In the tracking mode, the baseband processor 220 may refine the local code replica generation to best match the incoming satellite signal. After correctly tracking the signals, the baseband processor 220 may provide the measurements and data for computing the position and velocity of GNSS enabled receiver 200 to an on-board processing engine (not shown), performing time transfer, or collecting data to be post-processed by ground stations. In some aspects, the tracking mode is composed of an initial tracking mode and an enhanced tracking mode, where the enhanced tracking mode provides a better tracking resolution than the initial tracking mode.

The baseband processor 220 may be configured to gather tracking algorithms to find and follow a visible GNSS signal (e.g., Galileo E1 band signal), by means of synchronization to the incoming PRN code (known a priori), and removing errors as much as possible. In operation, the baseband processor 220 may receive the baseband representation of the incoming satellite signals, correlate the incoming signals with a locally generated code (e.g., PRN sequence or BOC×PRN sequence), and use the correlation results to determine the position of the GNSS enabled receiver 200.

The baseband processor 220 may be configured to generate a local code replica using PRN generator 224 and BOC generator 222 based on an input code delay, which indicates a quantity by which the local code replica should be shifted before correlating the local code replica with the incoming satellite signal. In some aspects, the BOC generator 222 is a square wave generator configured to produce a sequence of +1's and −1's. The PRN generator 224 is configured to replicate the PRN code known a priori that corresponds with a GNSS satellite.

At multiplier 226, the BOC generator 222 output is multiplied with the PRN generator 224 output to produce a local BOC×PRN sequence. In this respect, the incoming satellite signal carrying a BOC×PRN spreading sequence is correlated with the local BOC×PRN sequence to provide a (BOC×PRN)×(BOC×PRN) correlation output at the output of the correlator 232 (e.g., removing the PRN and BOC sequences from the incoming satellite signal). In certain aspects, the baseband processor 220 generates the local code replica using only the PRN generator 224. In this respect, the incoming satellite signal carrying the BOC×PRN spreading sequence is correlated with the local PRN sequence to provide a (BOC×PRN)×(PRN) correlation output at the output of correlator 234. In the initial tracking mode, the de-spreading operation may be performed through correlator 232. On the other hand, the de-spreading operation may be performed through correlator 234 when in the enhanced tracking mode.

The baseband processor 220 may be configured to generate a local prompt correlator such as a prompt replica to align with the incoming spreading code included in the incoming satellite signal. In some aspects, the baseband processor 220 includes additional local correlators including, but not limited to, an early correlator that provides a replica that is shifted earlier in time than the prompt replica, and a late correlator that provides a replica that is shifted later in time than the prompt replica. In this regard, the correlators 232 and 234 may be replicated for each of the early, late and prompt correlations.

Given that the baseband processor 220 can include multiple local correlators (e.g., early, prompt and late), the baseband processor 220 may be configured to correlate the incoming satellite signal with a respective de-spreading code to generate respective correlation results. In some implementations, the baseband processor 220 is configured to select between a first de-spreading code and a second de-spreading code based on a tap delay of a local reference waveform. In this respect, the first de-spreading code includes a binary offset carrier (BOC) modulation sequence of a pseudorandom noise sequence (e.g., the BOC×PRN sequence) and the second de-spreading code is the pseudorandom noise sequence (e.g., the PRN sequence). In turn, the baseband processor 220 may de-spread the input (e.g., the baseband representation) with the selected de-spreading code to generate a correlation output.

The local reference waveform may be predetermined such that the estimated correlation vector best matches the expected GNSS signal. In this regard, the local reference waveform may include a programmable number of taps with a specified tap spacing having a tap resolution of at least 1/16^{th} of a chipping rate. In Galileo, the chipping rate may be 1023 chips per epoch or 1.023 Megahertz (MHz). The local reference waveform may be programmed by controller 230, and adjusted by controller 230 based on GNSS measurements gathered by baseband processor 220.

The controller 230 may be configured to provide control signals to the switch 228 to select the desired de-spreading code. The controller 230 may include a non-transitory computer-readable medium that includes one or more instructions for providing the control signals to the switch 228. The control signals may be based on a tap delay of the local reference waveform such that the tap delay location dictates the selection between the two de-spreading code sequences. In this respect, the PRN de-spreading code may be selected for early and late taps to take advantage of the large dynamic range, and the BOC×PRN de-spreading code may be selected for only the prompt tap to take advantage of the larger discriminator gain. In Galileo, the incoming signal is modulated with both a PRN sequence and a BOC sequence (e.g., BOC×PRN). The correlation output from correlator 232 can include a (BOC×PRN)×(BOC×PRN) de-spreading calculation, and the correlation output from correlator 234 can include a (BOC×PRN)×(PRN) de-spreading calculation. As such, the prompt power may be based on the (BOC×PRN)×(BOC×PRN) de-spreading calculation during the initial tracking mode to provide for an unambiguous detection of the GNSS signal.

In the enhanced tracking mode of the GNSS enabled receiver 200, the controller 230 may be reconfigured such that the BOC×PRN de-spreading code is assigned to all taps (e.g., early, late and prompt taps) to take advantage of the narrower ACF peak. In this respect, the controller 230 may control the switch 228 to select the path to the correlator 232 so the I/Q samples are correlated with the BOC×PRN de-spreading code. Since the DLL can be locked to a correct correlation peak during the enhanced tracking mode, the narrower correlation peaks would provide a larger discriminator gain for better range resolution. If the DLL lost a lock on the correct correlation peak while in the enhanced tracking mode, the controller 230 may be reconfigured such that the PRN de-spreading code is reassigned to the early and late taps to allow the DLL re-lock. Thereafter, the controller 230 may reassign all the taps to the BOC×PRN de-spreading code to allow the DLL to lock with a better tracking resolution.

The baseband processor 220 also includes a delay-locked loop (DLL) discriminator 236 coupled to outputs of the correlators 232 and 234 and configured to receive the correlation results and align the local reference waveform with the incoming satellite signal based on an early-minus-late DLL discriminator function. The function may be expressed as:

$$\frac{\sum ( {I}_{L}^{2} + {Q}_{L}^{2} ) - \sum ( {I}_{E}^{2} + {Q}_{E}^{2} )}{{( {I}_{P}^{2} + {Q}_{P}^{2} )}_{Filtered}} \qquad ( 1 )$$

, where I_{L} and Q_{L}, are the late correlation results, I_{E} and Q_{E} are the early correlation results, both of which are correlated with the second de-spreading code, and I_{P} and Q_{P} are the prompt correlation results and are correlated with the first de-spreading code. In certain aspects, the DLL discriminator is configured as an early-minus-late (E-L) discriminator, a dot product E-L discriminator or a high resolution correlation (HRC) discriminator.

In certain aspects, the prompt replica (e.g., output from the correlator 232) is provided to the DLL discriminator 236, the PLL discriminator 238 and the FLL discriminator 240 for code delay, phase and frequency tracking operations. The early and late replicas (e.g., output from the correlator 234) are provided only to the DLL discriminator 236 for determining code delay corrections (in conjunction with the prompt replica).

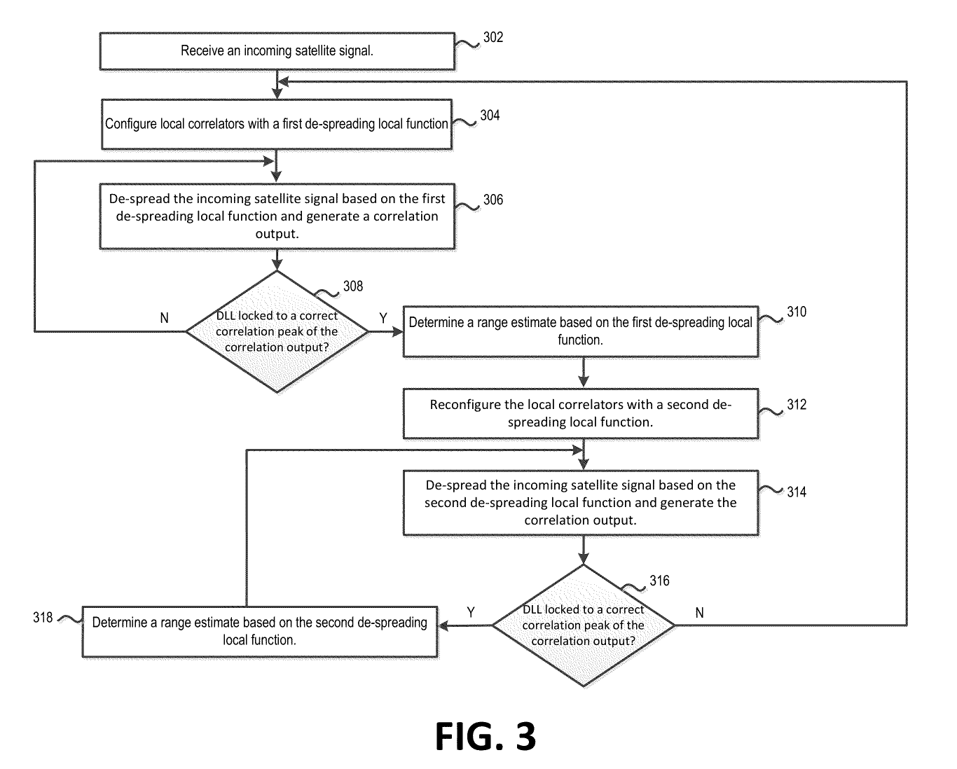

FIG. 3 is a flowchart illustrating an example of a method 300 of tracking a code phase, in accordance with various aspects of the subject technology. Not all of the depicted components may be required, however, and one or more implementations may include additional components not shown in the figure. Variations in the arrangement and type of the components may be made without departing from the spirit or scope of the claims as set forth herein. Additional components, different components, or fewer components may be provided.

The baseband processor 220 of FIG. 2, for example, may be used to implement method 300. However, method 300 may also be implemented by systems having other configurations. Although method 300 is described herein with reference to the examples of FIGS. 1 and 2, method 300 is not limited to these examples. Furthermore, although method 300 is illustrated in the order shown in FIG. 3, it is understood that method 300 may be implemented in a different order.

Method 300 includes processes S302, S304, S306, S308, S310, S312, S314, S316 and S318. Process S302 may be implemented by radio front-end 202. Processes S304 and S312 may be implemented by controller 230. Process S306 may be implemented by the correlator 232, while the process S314 may be implemented by the correlator 234. Processes S308, S310, S316 and S318 may be implemented by baseband processor 220. Although the processes implemented by baseband processor 220, controller 230, and correlators 232 and 234 are described as being part of method 300, the processes implemented by baseband processor 220, controller 230, and correlators 232 and 234 may, in certain aspects, be considered as separate methods.

According to process S302, an incoming satellite signal may be received by the radio front-end 202. The radio front-end 202 may downconvert the incoming satellite signal (e.g., at baseband frequency), and digitize the down-converted signal for processing by the baseband processor 220.

At process S304, the controller 230 may configure local correlators with a first de-spreading local function to represent an initial tracking mode. The first de-spreading local function may be determined based on a tap delay of a local reference waveform. The process S304 may include a process for determining the first de-spreading local function, which may include selecting between a first local code replica and a second local code replica. The first local code replica may be composed of a binary offset carrier (BOC) modulation sequence of a pseudorandom noise sequence (BOC×PRN) and the second local code replica may be the pseudorandom noise sequence (PRN). In some aspects, the selection between the BOC×PRN de-spreading code and the PRN de-spreading code is based on whether the tap delay corresponds to a prompt replica correlation or an early/late replica correlation. If the tap delay corresponds to the prompt replica correlation, then the BOC×PRN de-spreading code is selected to take advantage of the large discriminator gain. If the tap delay corresponds to the early/late replica correlations, then the PRN de-spreading code is selected to take advantage of the large dynamic range (e.g., wide slopes with low discriminator gain) for an unambiguous detection of the incoming GNSS signal. In this regard, the first de-spreading local function includes the local prompt correlator assigned with the BOC×PRN de-spreading code and the local early/late correlators assigned with the PRN de-spreading code.

According to process S306, the incoming satellite signal such as an incoming GNSS signal may be de-spread based on the first de-spreading local function to generate a correlation output. In this regard, the de-spreading local function includes the selected de-spreading code for de-spreading the incoming GNSS signal. At process S308, the correlation output may then be used by baseband processor 220 to determine a lock on one of the correlation peaks (e.g., main correlation peak that corresponds to the prompt replica) unambiguously. In this regard, the lock can be kept with subsequent code delay corrections to maintain synchronization with the GNSS satellites such as GNSS satellite 120a (FIG. 1).

In certain aspects, the process S306 includes a sub-process for aligning the local reference waveform with the incoming signal during a tracking mode based on an early-minus-late delay-locked loop (DLL) discriminator function, in which the early-minus-late DLL discriminator function is expressed as equation (1) shown above, where I_{L}, Q_{L}, I_{E} and Q_{E} are correlated with the second local code replica and I_{P} and Q_{P} are correlated with the first local code replica. In this respect, the first local code replica includes the BOC×PRN de-spreading sequence and the second local code replica includes the PRN de-spreading sequence.

According to process S308, if the DLL has not locked to a correct correlation peak (e.g., the prompt correlation peak), then the process returns to process S306 to regenerate the correlation output and allow the DLL to lock in the initial tracking mode. If the DLL does lock to the correct correlation peak of the correlation output, then the process proceeds to process S310, where a range estimate based on the first de-spreading local function can be determined. The range estimate at process S310 can be an initial measurement, which can be refined by process S312.

According to process S312, the local correlators can be reconfigured when a delay-locked loop has locked to a correct correlation peak of the local reference waveform based on the correlation output. In the initial tracking mode, the de-spreading local function is programmed (or set) with the prompt replica assigned to the BOC×PRN de-spreading code and the early/late taps assigned to the PRN de-spreading code. Once the DLL has locked in the initial tracking mode, the de-spreading system can enter an enhanced tracking mode. In the enhanced tracking mode, the local correlators are assigned with a second de-spreading local function such that the early/late taps are re-assigned to the BOC×PRN de-spreading code while the prompt replica remains assigned to the BOC×PRN de-spreading code. As such, the tracking loop can provide for better range resolution based on a correlation vector having narrower correlation peaks with larger discriminator gains on all tap delays. In this regard, the second de-spreading local function includes the local prompt correlator as well as the local early/late correlators assigned with the BOC×PRN de-spreading code.

While in the enhanced tracking mode, an algorithm evaluates the de-spreading system performance to determine whether to revert back to the initial tracking mode (e.g., at process S304). In some aspects, the controller 230 may include instructions stored on a non-transitory computer-readable medium representing the algorithm that monitors the DLL lock in the enhanced tracking mode. If the DLL is determined to have lost a lock on the correct correlation peak, then the controller 230 reconfigures the local correlators with the first de-spreading local function as shown in process S304. If the DLL lock is maintained during the enhanced tracking mode, then the method proceeds to process S314. According to process S314, a range estimate may be determined based on the second de-spreading local function. Here, the range estimate can be based on the larger discriminator gains of the reconfigured correlation vector. After the range estimate has been determined based on the higher range resolution, the tracking loop can continue tracking the incoming GNSS signal by de-spreading the signal with the second de-spreading local function and allow the DLL to lock in the enhanced tracking mode.

In one or more implementations, the method 300 includes a process for selecting a specified number of taps, selecting a specified chip spacing between the specified number of taps, and generating the local reference waveform based on the specified number of taps and the specified chip spacing between the taps, where the specified chip spacing is configured to be at least 1/16^{th} of a chip rate to a channel.

The method 300 also may include a process for assigning each of the specified number of taps to a BOC×PRN de-spreading code or a PRN de-spreading code, in which the BOC×PRN de-spreading code is associated with a prompt replica correlation and the PRN de-spreading code is associated with early and late replica correlations during the initial tracking mode of the GNSS enabled receiver 200, or in the alternative, the BOC×PRN de-spreading code is associated with the prompt, early and late replica correlations during the enhanced tracking mode of the GNSS enabled receiver 200.

In certain aspects, the specified number of taps includes multiple tap groups. In this regard, the method 300 may include a process for associating a first tap group with an early correlator, associating a second tap group with a prompt correlator, and associating a third tap group with a late correlator. As such, each tap group is correlated with a respective de-spreading code (e.g., PRN or BOC×PRN).

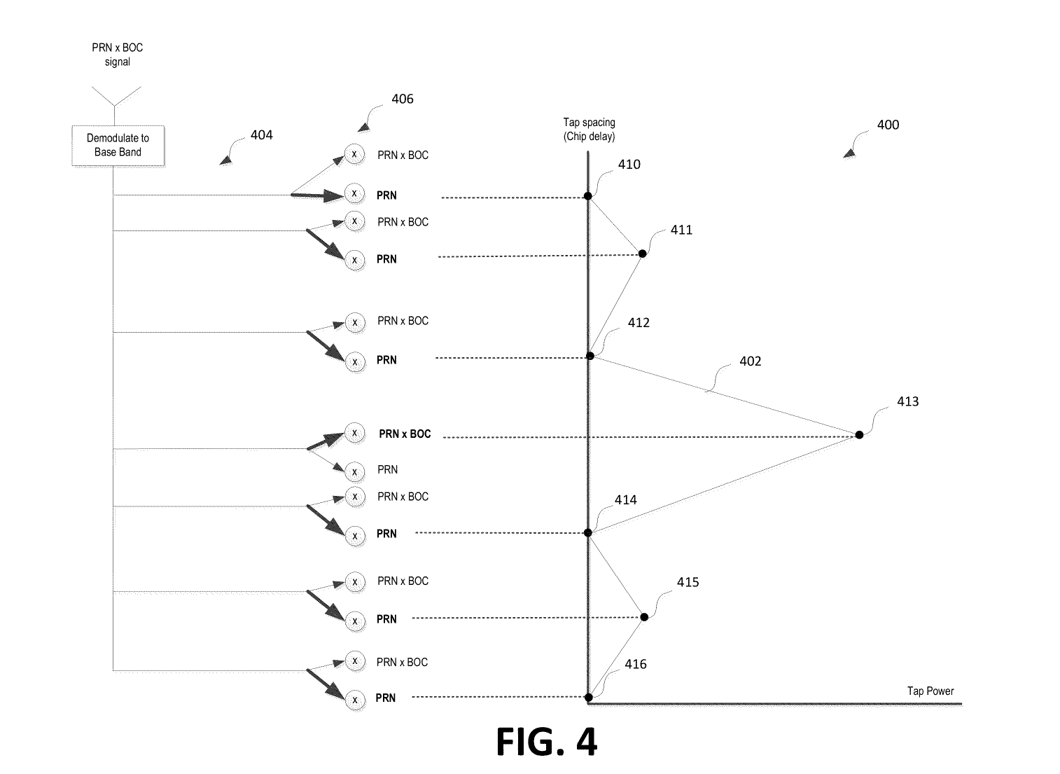

FIG. 4 is a diagram illustrating an example of a correlation 400 based on multiple delay taps, in accordance with various aspects of the subject technology. Not all of the depicted components may be required, however, and one or more implementations may include additional components not shown in the figure. Variations in the arrangement and type of the components may be made without departing from the spirit or scope of the claims as set forth herein. Additional components, different components, or fewer components may be provided.

The local reference waveform 402 includes a representation of a correlation function based on multiple de-spreading codes (e.g., BOC×PRN or PRN sequences). The local reference waveform includes tap delays 410-416, where tap delays 410-412 are denoted as early taps, tap delay 413 is denoted as prompt tap, and tap delays 414-416 are denoted as late taps. The local reference waveform 402 determines tap power as a function of tap spacing (or chip delay).

The local reference waveform 402 may be set (or programmed) with a specified number of taps in a range of three taps to eight taps, in which the specified number of taps are spaced apart by a specified chip delay of at least 1/16^{th} of a chip rate. As shown, the local reference waveform 402 includes seven (7) taps. In some aspects, the tap delays have a chip spacing of 0.25 chips depending on implementation.

In operation, the incoming satellite signal with BOC×PRN modulation is demodulated to baseband at a GNSS receiver (e.g., GNSS enabled receiver 200). The baseband signals 404 (e.g., I/Q samples) are de-spread using one of two selectable de-spreading codes at correlators 406 based on a tap delay of the local reference waveform 402. As such, a correlation vector may be generated based on the correlation output for each of the specified number of taps, where the correlation vector represents power calculations based on different de-spreading codes.

In some aspects, a method of tracking a code phase includes receiving an input representing an incoming radio frequency (RF) signal from one or more global navigation satellite system (GNSS) satellites, selecting between a first de-spreading code (e.g., BOC×PRN) and a second de-spreading code (e.g., PRN) based on a tap delay of a local reference waveform (e.g., local reference waveform 402), and de-spreading the input with the selected de-spreading code to generate a correlation output. At tap delays 410-412, the PRN de-spreading sequence is selected since tap delays 410-412 represent early tap correlations. At tap delay 413, the BOC×PRN de-spreading sequence is selected since tap delay 413 represents the prompt tap correlation. At tap delays 414-416, the PRN de-spreading sequence is again selected since tap delays 414-416 represent late tap correlations.

In some aspects, the first de-spreading code includes a locally generated replica of an incoming spreading code included in the incoming RF signal and the second de-spreading code comprises a subset of the incoming spreading code. In this respect, the locally generated replica of the incoming spreading code comprises a binary offset carrier (BOC) modulation sequence of a pseudorandom noise sequence (e.g., BOC×PRN) and the subset of the incoming spreading code is the pseudorandom noise sequence (e.g., PRN).

The correlation output corresponding to local reference waveform 402 may be provided to a delay-locked loop (DLL) to align the local reference waveform 402 with the incoming RF signal. Determining if the DLL locked to a correlation peak of the correlation vector can be based on whether the correlation peak has a slope that is greater than slopes of peaks at remaining taps of the correlation vector. In this respect, the prompt power corresponding to tap delay 414 can be used to normalize the DLL and remaining PLL and FLL tracking functions. In case the DLL is locked on the main peak, the incoming RF signal can be correlated (or de-spread) with the same de-spreading code in a closed-loop for all tap delays. The de-spreading operation during the tracking mode is based on the early/late tap delays being reassigned from the PRN de-spreading sequence to the BOC×PRN de-spreading sequence to take advantage of the narrower ACF peak with larger discriminator gains for better range resolution.

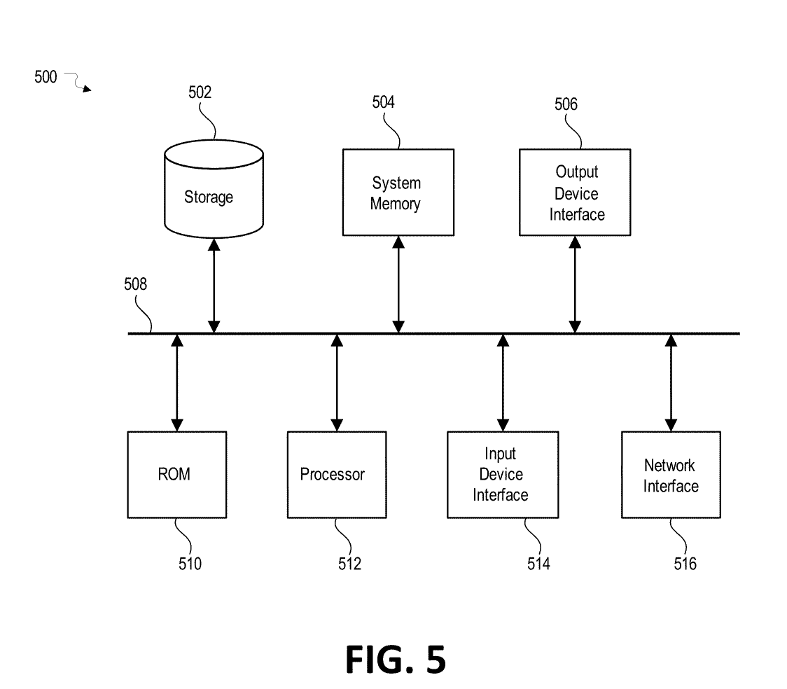

FIG. 5 conceptually illustrates an electronic system 500 with which one or more implementations of the subject technology may be implemented. Not all of the depicted components may be required, however, and one or more implementations may include additional components not shown in the figure. Variations in the arrangement and type of the components may be made without departing from the spirit or scope of the claims as set forth herein. Additional components, different components, or fewer components may be provided.

The electronic system 500, for example, can be a laptop computer, a tablet computer, a receiver, a phone, a personal digital assistant (PDA), or generally any electronic device that transmits wireless signals over a network. In some aspects, the electronic system 500 is a stand-alone device that does not necessarily communicate over a network. The electronic system 500 can be, and/or can be a part of GNSS enabled receiver 200 (FIG. 2) or GNSS-enabled mobile devices 110a-110c. Such an electronic system 500 includes various types of computer readable media and interfaces for various other types of computer readable media. The electronic system 500 includes a bus 508, one or more processing unit(s) 512, a system memory 504, a read-only memory (ROM) 510, a permanent storage device 502, an input device interface 514, an output device interface 506, a local area network (LAN) interface 516, and a wide area network (WAN) interface 518, or subsets and variations thereof

The bus 508 collectively represents all system, peripheral, and chipset buses that communicatively connect the numerous internal devices of the electronic system 500. In one or more implementations, the bus 508 communicatively connects the one or more processing unit(s) 512 with the ROM 510, the system memory 504, and the permanent storage device 502. From these various memory units, the one or more processing unit(s) 512 retrieves instructions to execute and data to process in order to execute the processes of the subject disclosure. The one or more processing unit(s) 512 can be a single processor or a multi-core processor in different implementations.

The ROM 510 stores static data and instructions that are needed by the one or more processing unit(s) 512 and other modules of the electronic system 500. The permanent storage device 502, on the other hand, may be a read-and-write memory device. The permanent storage device 502 may be a non-volatile memory unit that stores instructions and data even when the electronic system 500 is off. In one or more implementations, a mass-storage device (such as a magnetic or optical disk and its corresponding disk drive) may be used as the permanent storage device 502.

In one or more implementations, a removable storage device (such as a flash drive or a universal serial bus (USB) drive) may be used as the permanent storage device 502. Like the permanent storage device 502, the system memory 504 may be a read-and-write memory device. However, unlike the permanent storage device 502, the system memory 504 may be a volatile read-and-write memory, such as random access memory. The system memory 504 may store any of the instructions and data that one or more processing unit(s) 512 may need at runtime. In one or more implementations, the processes of the subject disclosure are stored in the system memory 504, the permanent storage device 502, and/or the ROM 510. From these various memory units, the one or more processing unit(s) 512 retrieves instructions to execute and data to process in order to execute the processes of one or more implementations.

The bus 508 also connects to the input and output device interfaces 514 and 506. The input device interface 514 enables a user to communicate information and select commands to the electronic system 500. Input devices that may be used with the input device interface 514 may include, for example, alphanumeric keyboards and pointing devices (also called “cursor control devices”). The output device interface 506 may enable, for example, the display of images generated by electronic system 500. Output devices that may be used with the output device interface 506 may include, for example, printers and display devices, such as a liquid crystal display (LCD), a light emitting diode (LED) display, an organic light emitting diode (OLED) display, a flexible display, a flat panel display, a solid state display, a projector, or any other device for outputting information. One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

Finally, as shown in FIG. 5, the bus 508 also couples the electronic system 500 to a network (not shown) through the LAN interface 516 and separately, or jointly, through the WAN interface 518. In this manner, the electronic system 500 can be a part of a network of computers, such as a LAN through the LAN interface 516, a WAN through the WAN interface 518, an Intranet through either of the interfaces 516, 518, or a network of networks through either of the interfaces 516, 518, such as the Internet. Any or all components of the electronic system 500 can be used in conjunction with the subject disclosure.

In some aspects, the electronic system 500 includes a GNSS receiver having a dedicated hardware configuration and one or more processors such that the one or more processors are programmed to execute local correlation algorithms and to manage the dedicated hardware configuration such that a number of delays and spacing between the delays implemented in dedicated hardware configuration are programmable. A correlation function is implemented that correlates a received signal from a Galileo E1 band satellite, for example, and a local receiver pattern. The correlation function for each delay also may be programmable. For each delay, the received signal, which is modulated as PRN×BOC(1,1), is correlated with either a local PRN×BOC or PRN. Instructions executable by the one or more processors can be executed to configure the dedicated hardware configuration first to calculate the correlation as a mix of BOC×PRN and PRN to take advantage of the softer slope of (BOC×PRN)_{rec}×(PRN)_{local}. The instructions can be executed by the one or more processors to calculate a discriminator metric for a delay locked loop (DLL). Once the DLL has converged successfully, the local correlator method of calculation and other properties can be changed to take advantage of the narrower peak of the PRN×BOC while observing the de-spreading system performance for determining whether to reconfigure the early and late correlators back to PRN if a loss of lock by the DLL occurs.

Implementations within the scope of the present disclosure can be partially or entirely realized using a tangible computer-readable storage medium (or multiple tangible computer-readable storage media of one or more types) encoding one or more instructions. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In some implementations, the tangible computer-readable storage medium can be directly coupled to a computing device, while in other implementations, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessor or multi-core processors that execute software, one or more implementations are performed by one or more integrated circuits, such as application specific integrated circuits (ASICs) or field programmable gate arrays (FPGAs). In one or more implementations, such integrated circuits execute instructions that are stored on the circuit itself.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration.” Any embodiment described herein as “exemplary” or as an “example” is not necessarily to be construed as preferred or advantageous over other embodiments. Furthermore, to the extent that the term “include,” “have,” or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. A method of tracking a code phase, the method comprising:
configuring local correlators with a first de-spreading local function;
de-spreading an incoming signal with the first de-spreading local function to generate a first correlation output;
determining a range estimate based on the first de-spreading local function;
reconfiguring the local correlators with a second de-spreading local function when a delay-locked loop has locked to a correct correlation peak of the first correlation output;
de-spreading the incoming signal with the second de-spreading local function to generate a second correlation output;
determining a range estimate based on the second de-spreading local function that has a higher resolution than the range estimate based on the first de-spreading local function; and
determining if the delay-locked loop has lost a lock on the correct correlation peak of the second correlation output to reconfigure the local correlators with the first de-spreading local function.

2. The method of claim 1, wherein the first de-spreading local function comprises a binary offset carrier (BOC) modulation sequence of a pseudorandom noise sequence (BOC×PRN) and the second de-spreading local function is the pseudorandom noise sequence (PRN).

3. The method of claim 2, further comprising aligning the local reference waveform with the incoming signal based on an early-minus-late delay-locked loop (DLL) discriminator function, wherein the function is expressed as
$$\frac{\sum ( {I}_{L}^{2} + {Q}_{L}^{2} ) - \sum ( {I}_{E}^{2} + {Q}_{E}^{2} )}{{( {I}_{P}^{2} + {Q}_{P}^{2} )}_{Filtered}} ,$$
where I_{L}, Q_{L}, I_{L} and Q_{E} are correlated with the second local code replica and I_{P} and Q_{P} are correlated with the first local code replica.

4. The method of claim 1, further comprising:
selecting a specified number of taps;
selecting a specified chip spacing between the specified number of taps; and
generating the local reference waveform based on the specified number of taps and the specified chip spacing between the taps,
wherein the specified chip spacing is configured to be at least 1/16^{th} of a chip rate to a channel.

5. The method of claim 4, further comprising:
assigning each of the specified number of taps to a BOC×PRN de-spreading code or a PRN de-spreading code, wherein the BOC×PRN de-spreading code is associated with a prompt correlation and the PRN de-spreading code is associated with early and late correlations during an initial tracking mode.

6. The method of claim 4, wherein the specified number of taps comprises a plurality of tap groups, further comprising:
associating a first tap group of the plurality of tap groups with an early correlator;
associating a second tap group of the plurality of tap groups with a prompt correlator; and
associating a third tap group of the plurality of tap groups with a late correlator.

7. The method of claim 6, further comprising:
assigning the early and late correlators to a PRN de-spreading code and the prompt correlator to a BOC×PRN de-spreading code during an initial tracking mode.

8. The method of claim 7, further comprising:
providing the correlation output to a delay-locked loop (DLL) to align the local reference waveform with the incoming signal;
determining if the DLL locked to a correct correlation peak of the local reference waveform, wherein the reconfiguring comprises reassigning the early and late correlators to the BOC×PRN de-spreading code during an enhanced tracking mode.

9. A method of tracking a code phase, the method comprising:
receiving an input representing an incoming radio frequency (RF) signal from one or more global navigation satellite system (GNSS) satellites;
selecting between a first de-spreading code and a second de-spreading code based on a tap delay of a local reference waveform; and
de-spreading the input with the selected de-spreading code to generate a correlation output.

10. The method of claim 9, wherein the first de-spreading code comprises a locally generated replica of an incoming spreading code included in the incoming RF signal and the second de-spreading code comprises a subset of the incoming spreading code.

11. The method of claim 10, wherein the locally generated replica of the incoming spreading code comprises a binary offset carrier (BOC) modulation sequence of a pseudorandom noise sequence and the subset of the incoming spreading code is the pseudorandom noise sequence.

12. The method of claim 9, wherein the local reference waveform comprises a specified number of taps, wherein de-spreading the input comprises generating a correlation vector based on the correlation output for each of the specified number of taps, and wherein the correlation vector comprises power calculations based on different de-spreading codes.

13. The method of claim 9, further comprising providing the correlation output to a delay-locked loop (DLL) to align the local reference waveform with the incoming RF signal.

14. The method of claim 13, further comprising:
determining if the DLL is locked to a correct correlation peak of the correlation output when in an initial tracking mode;
de-spreading the input with a same de-spreading code for all delay taps of the local reference waveform in an enhanced tracking mode when the DLL is determined to be locked on the correct correlation peak in the initial tracking mode; and
determining if the DLL is locked to the correct correlation peak when in the enhanced tracking mode; and
returning to the initial tracking mode when the DLL is determined to be not locked to the correct correlation peak.

15. The method of claim 9, further comprising setting the local reference waveform with a specified number of taps in a range of three taps to eight taps, wherein the specified number of taps are spaced apart by a specified chip delay of at least 1/16^{th} of a chip rate.

16. A global navigation satellite system (GNSS) receiver, comprising:
a radio frequency (RF) front-end configured to receive an incoming RF signal from one or more GNSS satellites; and
a baseband processor communicatively coupled to the RF front-end and configured to:
receive an input representing the incoming RF signal;
select between a first de-spreading code and a second de-spreading code based on a tap delay of a local reference waveform; and
de-spread the input with the selected de-spreading code to generate a correlation output, wherein the first de-spreading code comprises a binary offset carrier (BOC) modulation sequence of a pseudorandom noise sequence (BOC×PRN) and the second de-spreading code is the pseudorandom noise sequence (PRN).

17. The GNSS receiver of claim 16, wherein the baseband processor comprises:
a plurality of correlators configured to correlate the incoming RF signal with a respective de-spreading code to generate respective correlation results; and
a delay-locked loop (DLL) discriminator coupled to outputs of the plurality of correlators and configured to receive the correlation results and align the local reference waveform with the incoming RF signal based on an early-minus-late delay-locked loop (DLL) discriminator function, wherein the function is expressed as
$$\frac{\sum ( {I}_{L}^{2} + {Q}_{L}^{2} ) - \sum ( {I}_{E}^{2} + {Q}_{E}^{2} )}{{( {I}_{P}^{2} + {Q}_{P}^{2} )}_{Filtered}} ,$$
where I_{L}, Q_{L}, I_{E} and Q_{E} are correlated with the second de-spreading code and I_{P} and Q_{P} are correlated with the first de-spreading code.

18. The GNSS receiver of claim 17, wherein the DLL discriminator is configured as an early-minus-late (E-L) discriminator, a dot product E-L discriminator or a high resolution correlation (HRC) discriminator.

19. The GNSS receiver of claim 17, wherein the GNSS receiver is one of a global positioning system (GPS) receiver, a global orbiting navigation satellite system (GLONASS) receiver, a Compass receiver, or a Galileo receiver.

20. A computer program product comprising instructions stored in a tangible computer-readable storage medium, the instructions comprising:
instructions for receiving an input representing an incoming radio frequency (RF) signal from one or more global navigation satellite system (GNSS) satellites;
instructions for selecting between a first local code replica and a second local code replica based on a tap delay of a local reference waveform, wherein the first local code replica comprises a binary offset carrier (BOC) modulation sequence of a pseudorandom noise sequence (BOC×PRN) and the second local code replica is the pseudorandom noise sequence (PRN); and
instructions for de-spreading the baseband signal with the selected local code replica to generate a correlation output.
